(19) United States
(12) Patent Application Publication
(10) Pub. No.: US 2006/0019130 A1
(43) Pub. Date: Jan. 26, 2006

(54) OMS-2 catalysts in PEM fuel cell applications

(76) Inventors: Sai P. Katikaneni, Danbury, CT (US); Pinakin Patel, Danbury, CT (US); Steven L. Suib, Storrs, CT (US)

Correspondence Address: COWAN LIEBOWITZ & LATMAN, P.C;JOHN J TORRENTE, 1133 AVENUE OF THE AMERICAS, NEW YORK, NY, 10036, US

(21) Appl. No.: 10/894,993

(22) Filed: Jul. 20, 2004

(51) Int. Cl. H01M 8/04

(52) U.S. Cl. 429/13; 429/34; 423/247

(57) ABSTRACT

A PEM fuel cell system in which an oxidizer is provided and in which the catalyst for the oxidizer is an OMS-2 catalyst and, in particular, an M-OMS-2 catalyst. Preferable catalysts are Co-OMS-2, Cu-OMS-2 and Ag-OMS-2 and, more preferably, Ag-OMS-2. Also, the effectiveness of the oxidizer is enhanced by one or more of the controlled addition of oxidant to the fuel feed and/or oxidizer, controlling the space velocity of the fuel feed and controlling the operating temperature of the oxidizer. A system for regeneration of the M-OMS-2 catalyst and a method of making the catalyst are additionally provided.

### BACKGROUND OF THE INVENTION

This invention relates to catalysts and, and, in particular, to catalysts for use in proton exchange membrane fuel cell applications.

A fuel cell is a device which directly converts chemical energy stored in hydrocarbon fuel into electrical energy by means of an electrochemical reaction. A fuel cell generally comprises an anode and a cathode separated by an electrolyte, which serves to conduct electrically charged ions. Proton exchange membrane (“PEM”) fuel cells operate at a relatively low temperature (approximately 80-120° Celsius) by passing a hydrogen fuel gas through the anode in the presence of a catalyst, while passing oxidizing gas through the cathode. PEM fuel cells typically include a platinum catalyst to facilitate the electrochemical reaction within the cell.

Hydrogen rich fuel for use in a PEM fuel cell is usually produced by reforming and further processing hydrocarbon fuel such as natural gas, gasoline and methanol. However, hydrogen rich fuel, or reformate gas, obtained from hydrocarbon fuel has a high concentration of carbon monoxide. Carbon monoxide poisons the platinum catalyst in the anode of the PEM fuel cell, thereby significantly deteriorating the fuel cell performance.

Performance and reliability of PEM fuel cells may be improved by reducing the concentration of carbon monoxide in the reformed hydrocarbon fuel to less than 20 ppm through physical or chemical processes. Conventional carbon monoxide removal processes include adsorption, membrane separation, absorption, selective methanation and preferential oxidation.

These processes, however, all have features which detract from their usefulness. For example, physical removal of carbon monoxide by adsorption requires a portion of the hydrogen stream to be used as a sweep gas for regenerating the adsorbent. Membrane separation, on the other hand, is significantly affected by the partial pressure of hydrogen and requires high-pressure operation with a carbon monoxide slip stream.

The chemical removal processes also have certain drawbacks. Thus, selective methanation reactions consume a significant amount of hydrogen. Absorption, on the other hand, requires high heat loading in order to remove carbon monoxide.

Preferential oxidation (“PROX”) is the currently favored chemical process for removal of carbon monoxide. This process typically uses a low temperature shift reactor followed by a staged preferential oxidizer for oxidizing carbon monoxide using oxygen in the presence of a noble metal catalyst, i.e., platinum, palladium-cobalt, palladium-copper and gold catalyst have been used. However, PROX processes have a high parasitic hydrogen consumption, and are generally complex, requiring three to four stages in order to achieve carbon monoxide concentrations that are sufficiently low for PEM fuel cell operation. Moreover, conventional PROX processes have a slow response and a low tolerance for large carbon monoxide transients.

In an article entitled “Sorption, catalysis, and separation by design” by S. Suib (Chemical Innovation, March 2000, Vol. 30, No 3, pp. 27-33), it has also been proposed generally to use octahedral molecular sieves (“OMS”) as catalysts to oxidize carbon monoxide. OMS-containing materials, such as synthetic todorokite (Mg²⁺_{0.98-1.35}Mn³⁺_{1.89-1.94}M⁴⁺_{4.38-4.54}O₁₂ 4.47-4.55H₂O) or cryptomelane (K-hollandite, KMns₈O₁₆nH₂O), comprise manganese oxide octahedral compounds linked by edges and vertices and forming uniform tunnels therethrough. Transition metal cations may be incorporated in the tunnels of the OMS compounds. Metal cation doped cryptomelane compounds have been mentioned in the aforesaid article as a specifically efficient catalysts in carbon monoxide oxidation. U.S. Pat. Nos. 5,695,618, 5,702,674, 5,597,944 and 5,635,155 describe synthesis methods and applications for these catalysts and specifically mention the synthesis of Co and Cu doped structures.

As used herein, manganese oxide octahedral molecular sieves (OMS) possessing the 2×2 tunnel structure (as in the aforementioned cryptomelane) will be referred to by the designation OMS-2 and the corresponding framework-substituted and tunnel-substituted molecular sieves will be referred to by the designations [M]-OMS-2 and [M-OMS-2], respectively, where M indicates tunnel or framework-substituted metal cation(s) other than manganese. Moreover, as used herein the designation M-OMS-2 refers [M]-OMS-2 and [M-OMS-2] individually and collectively.

As can be appreciated from the above, an improved catalyst for the removal of carbon monoxide from the fuel feed of a PEM fuel cell is still desired. Moreover, the catalyst must be low in cost, result in little hydrogen consumption and be adaptable to transient changes in the carbon monoxide concentration.

It is therefore an object of the present invention to provide an improved catalyst for the removal of carbon monoxide from the fuel feed of a PEM fuel cell;

It is also an object of the present invention to provide a catalyst of the above type which is able to adapt to transient changes in the carbon monoxide concentration.

It is yet a further object of the present invention to provide a catalyst of the above type which minimizes hydrogen consumption.

It is yet a further object of the present invention to provide a PEM fuel cell system and method having an oxidizer and oxidizing process for the removal of the carbon monoxide in the hydrocarbon fuel feed to a PEM fuel cell which employs a catalyst able to tolerate transient carbon monoxide conditions and which minimizes hydrogen consumption.

### SUMMARY OF THE INVENTION

In accordance with the principles of the present invention, the above and other objectives are realized in a PEM fuel cell system in which an oxidizer is provided and in which the catalyst for the oxidizer is an OMS-2 catalyst. In further accord with the invention, the OMS-2 catalyst is an M-OMS-2 catalyst. Preferable catalysts are Co-OMS-2, Cu-OMS-2 and Ag-OMS-2 and, more preferably, Ag-OMS-2. Also, in accord with the invention, the effectiveness of the oxidizer is enhanced by one or more of the controlled addition of oxidant to the fuel feed and/or oxidizer, controlling the space velocity of the fuel feed and controlling the operating temperature of the oxidizer. Additionally disclosed, in accord with the invention, is a system for regeneration of the OMS-2 catalyst and a method of making the catalyst.

### BRIEF DESCRIPTION OF THE DRAWINGS

The above and other features and aspects of the present invention will become more apparent upon reading the following detailed description in conjunction with the accompanying drawings, in which:

FIG. 1 shows a PEM fuel cell system utilizing an oxidizer having an OMS-2 catalyst in accordance with the principles of the present invention

FIG. 2 shows a schematic view of an Ag-OMS-2 catalyst structure usable as the OMS-2 catalyst of the oxidizer of FIG. 1;

FIG. 3 shows a graph of performance data of OMS-2 catalysts usable in the oxidizer of FIG. 1 in comparison with performance data for conventional oxidation catalysts;

FIG. 4 shows a graph of performance data and maximum carbon monoxide conversion temperatures for OMS-2 catalysts usable in the oxidizer of FIG. 1;

FIG. 5 shows a graph of performance data of the Ag-OMS-2 catalyst of FIG. 2 over a period of 200 minutes;

FIG. 6 shows a graph of performance data of the Ag-OMS-2 catalyst of FIG. 2 over a period of 10,000 minutes using a simulated reformate gas with added oxygen and a space velocity of 500 h⁻¹;

FIG. 7 shows a graph of performance data of the Ag-OMS-2 catalyst of FIG. 2 over a period of 200 minutes using a simulated reformate gas with added oxygen and a space velocity of 250 h⁻¹;

FIG. 8 shows a graph of breakthrough durations of 100% carbon monoxide conversion at different temperatures for the oxidizer of FIG. 1;

FIG. 9 shows a graph of partial pressures of the reformate gas components over a period of 200 minutes for the system of FIG. 1;

FIG. 10 shows a graph of partial pressures of the reformate gas components at different temperatures;

FIGS. 11 and 12 show performance characteristics of the Ag-OMS-2 catalysts after undergoing a number of regeneration cycles; and

FIG. 13 shows the details of an oxidizer and other components, including regeneration and oxidant supply components, which can be used in the system of FIG. 1.

### DETAILED DESCRIPTION

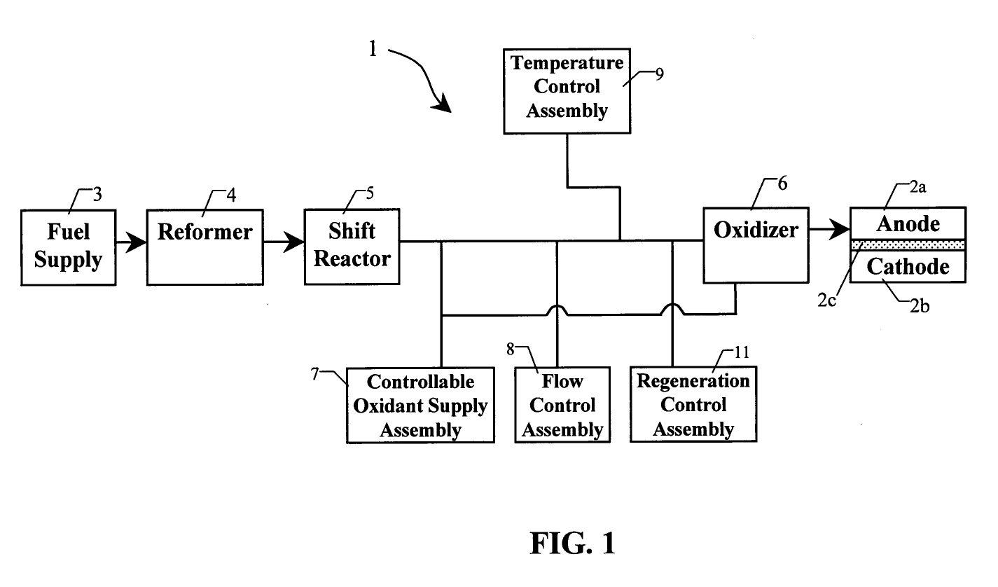

FIG. 1 shows a PEM fuel-cell system in accordance with the principles of the present invention. As shown, the system 1 comprises a PEM fuel cell 2 having an anode section 2a and a cathode section 2b separated by a PEM 2c. A fuel supply 3 provides a hydrocarbon fuel, such as, for example, natural gas, gasoline or methanol, to a reformer unit 4 which converts the hydrocarbon fuel to a PEM fuel feed or reformate which is rich in hydrogen. The fuel feed also contains substantial levels of carbon monoxide gas, typically greater than 20,000 ppm.

The PEM fuel cell feed from the reformer 4 is then passed through a low temperature shift reactor 5 in which a portion of the carbon monoxide gas is converted to carbon dioxide, thereby reducing its level, typically to about 2,000 ppm. An oxidizer 6 follows the shift reactor and is adapted to oxidize a further portion of the remaining carbon monoxide in the PEM fuel cell feed so that the level of carbon monoxide is less than about 20 ppm. The resultant PEM fuel cell feed is then delivered from the oxidizer to the anode section 2a of the PEM fuel cell 2, whereby the fuel undergoes electrochemical reaction with the oxidant supplied to the cathode section 2a of the fuel cell to thereby produce electrical energy.

In accordance with the principles of the present invention, the oxidizer 6 is adapted to oxidize the carbon monoxide in the PEM fuel feed in such a manner as to readily handle transients in the level of carbon monoxide and with limited hydrogen consumption. This is realized in accordance with the invention by using an OMS-2 catalyst in the oxidizer 6. As previously discussed, OMS-2 catalysts are octahedral molecular sieves of, as, for example, cryptomelane (K-hollandite, KMn₈O₁₆nH₂O). The OMS-2 catalysts thus comprise manganese oxide octahedral compounds linked by edges and vertices and forming uniform tunnels therethrough. As also previously discussed, metal cations may be incorporated in the tunnels of the OMS compounds.

In further accord with the invention, the OMS-2 catalyst of the oxidizer 6 is a metal cation doped OMS-2 catalyst, i.e., an M-OMS-2 catalyst. Preferably, the M-OMS-2 catalyst is one of a Co-OMS-2 catalyst, a Cu-OMS-2 catalyst and a Ag-OMS-2 catalyst, and, more preferably, the M-OMS-2 catalyst is a Ag-OMS-2 catalyst.

These catalysts have been found to have excellent catalytic activity toward carbon monoxide oxidation at low temperatures in the presence of high concentrations of hydrogen. This is believed to result from the high surface area, smaller pore size, more acid sites and greater defects (primarily oxygen vacancies) exhibited by these catalysts when prepared as described below. Accordingly, due to the use of the OMS-2 catalysts in the oxidizer 6, the oxidizer is able to lower the carbon monoxide level in the PEM fuel cell feed to desired levels (less than 20 ppm) efficiently and responsively to carbon monoxide transients

As previously mentioned, Ag-OMS-2, e.g., Ag doped cryptomelane (Ag_{0.01-0.03}K_{0.03-0.04}MnO₂xH₂O), is the most preferred catalyst for the oxidizer 6. This preference is based on the recognition that the operating temperature profile of the Ag-OMS-2 catalyst is most compatible with that of the PEM fuel cell 2. As a result, the oxidizer 6 provided with an Ag-OMS-2 catalyst can be best thermally efficiently integrated with the fuel processor and the PEM fuel cell 2. The operating temperature profiles of the Ag-OMS-2 catalyst, as well as the Cu-OMS-2 and Co-OMS-2 catalysts, will be discussed further hereinbelow.

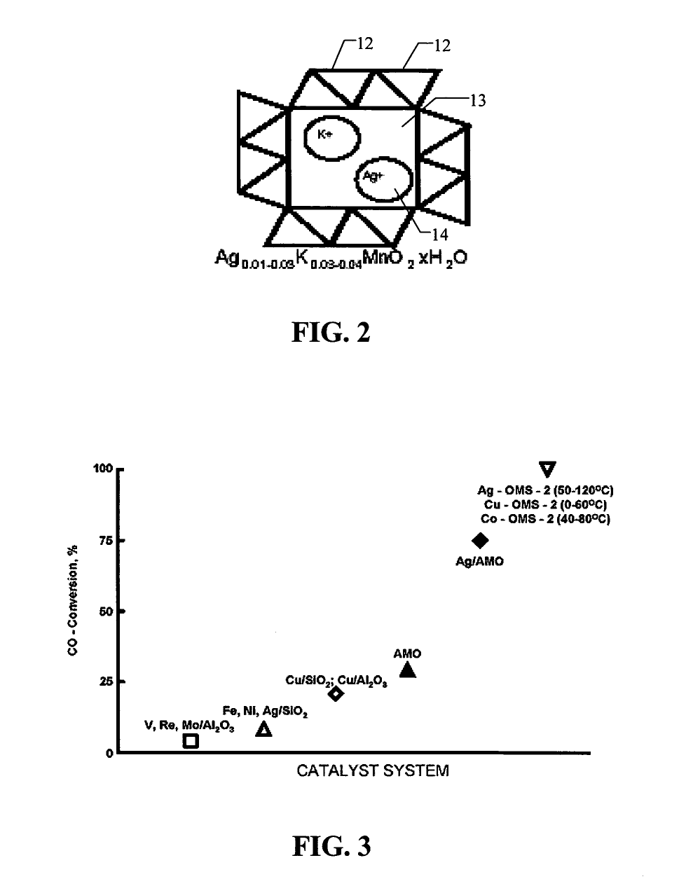

FIG. 2 schematically shows an example of the structure of the M-OMS-2 catalysts of the invention and, in particular, the Ag-OMS-2 catalyst structure. As can be seen, the structure includes a plurality of basic OMS units 12 having an octahedral shape and arranged to form a 3-dimensional 2×2 tunnel 13. Ag (silver) metal cations 14 are incorporated in the tunnel 13 formed by the OMS-2 units 12. The other M-OMS-2 catalysts have similar structures, except that the dopant incorporated into the units 12 is the particular metal cation of the catalyst, e.g. Cu, Co, etc. The M-OMS-2 catalysts with such structure, prepared as described herinbelow, have a unique pore structure and include active sites for carbon monoxide oxidation reactions.

More particularly, as previously mentioned, the M-OMS-2 catalysts of the invention cause selective oxidation of the carbon monoxide of the fuel feed delivered to the oxidizer 6. This occurs chemically via a sorption-chemical oxidation process aided by the above-mentioned unique pore structure and active sites of the catalyst. An example of this sorption-chemical oxidation process with Ag-OMS-2 as the catalyst is next described.

Specifically, the sorption-chemical oxidation of carbon monoxide over the Ag-OMS-2 catalyst is carried out at low temperatures in two stages, a sorption stage and a chemical oxidation stage. During the sorption stage, carbon monoxide is selectively adsorbed on the metal active side of the Ag-OMS-2 catalyst as follows:
Ag*+CO→CO_{ad} (1)

This process then proceeds to the chemical oxidation stage in which carbon monoxide is chemically oxidized with oxygen typically present in the OMS-2 tunnel or provided with the fuel feed or reformate gas. Specifically, oxygen from the OMS-2 tunnel is released in the following reaction:
O-OMS-2→OMS-2+½O₂ (2)
Subsequently, carbon monoxide is oxidized by reacting carbon monoxide with the released oxygen to produce carbon dioxide in the following reaction:
CO_{ad}+½O₂→CO₂+Ag* (3)

As will be discussed more fully hereinbelow and in further accordance with the invention, following the sorption-chemical oxidation reaction, the OMS-2 can be regenerated in situ by adding oxygen from a feed gas to produce an O-OMS-2 regenerative substrate. This reaction is as follows:
OMS-2+½O₂+O-OMS-2 (4)

The M-OMS-2 oxidation catalysts of the invention are prepared using a precipitation and reflux method. This method includes the steps of precipitation, refluxing, filtration and calcination. The method is illustrated in the following Example 1 which demonstrates use of the method in the preparation of an Ag-OMS-2 catalyst. Other M-OMS-2 catalysts, including the above-mentioned Cu-OMS-2 and Co-OMS-2 catalyst, can be similarly prepared.

### EXAMPLE 1

In this example, synthesis of an Ag-OMS-2 catalyst is carried out using the above-mentioned four steps, i.e. precipitation, refluxing, filtration and calcination. In the precipitation step, a first solution comprising 50 mmol KMnO₄ and an appropriate amount of AgNO₃ dopant is mixed with a second solution comprising appropriate amounts of Mn (II) salt, such as Mn(NO₃)₂, and HNO₃. A dark-brown precipitate is formed upon mixing the first and second solutions together.

Control parameters in the precipitation step include the ratio between Mn(II) and Mn(VII), the initial concentration of dopant cations, the pH value of the resulting precipitate slurry, the mixing sequence and mixing time. In this example, the initial concentration of the Ag+ cation is between 0.0001M and 0.05M, and the ratio between Mn(II) and MN(VII) is controlled such that the average oxidation state values of Mn are set between 2.8 and 4.0, and preferably between 3.7 and 4.0. The mixing sequence in this example allows the first solution to be added to the second solution, and vice versa. The precipitate slurry resulting from the mixture of the first and second solutions has a pH of about 1 and is allowed to age over 5 hours before proceeding to the second step.

In the second step, the precipitate is refluxed for about 24 hours. This precipitate is thereafter filtered and washed with deionized water during the filtration step of the synthesis process. The resulting solid material comprising Ag-OMS-2 is then dried at 100 to 150° Celsius and calcinated at 350° Celsius for 2 hours. Ag-OMS-2 prepared using the above synthesis process can be then pelletized and sieved to result in particles ranging in size from 20 to 60 mesh. The pellets can then be placed in a packed bed or other configuration to form the oxidizer 6.

Ag-OMS-2, Cu-OMS-2 and CO-OMS-2 catalyst samples prepared according to the above method of the invention were tested in a bench scale packed bed microreactor with an attached Gas Chromatography-Mass Spectroscopy (“GC-MS”) system for analyzing product distribution in a reformate gas oxidized using the catalyst samples to a ppm level. A simulated PEM fuel cell feed or reformate gas during these tests comprised 2000 ppm carbon monoxide, 75% hydrogen concentration and 25% carbon dioxide. These tests were performed at 100° Celsius and 500 h⁻¹ space velocity of the reformate gas. The performance of the M-OMS-2 catalysts and of other conventional oxidation catalysts in oxidizing carbon monoxide was measured during these tests.

FIG. 3 shows a graph of performance data for the M-OMS-2 catalyst samples as compared to the performance data for conventional oxidation catalysts comprising V, Re, Mo and Cu supported on alumina and silica. As shown, the Ag-OMS-2, Cu-OMS-2 and Co-OMS-2 catalysts achieved 100% conversion of carbon monoxide to carbon dioxide, while the conventional oxidation catalysts had significantly lower carbon monoxide conversion rates, i.e. less than 75%.

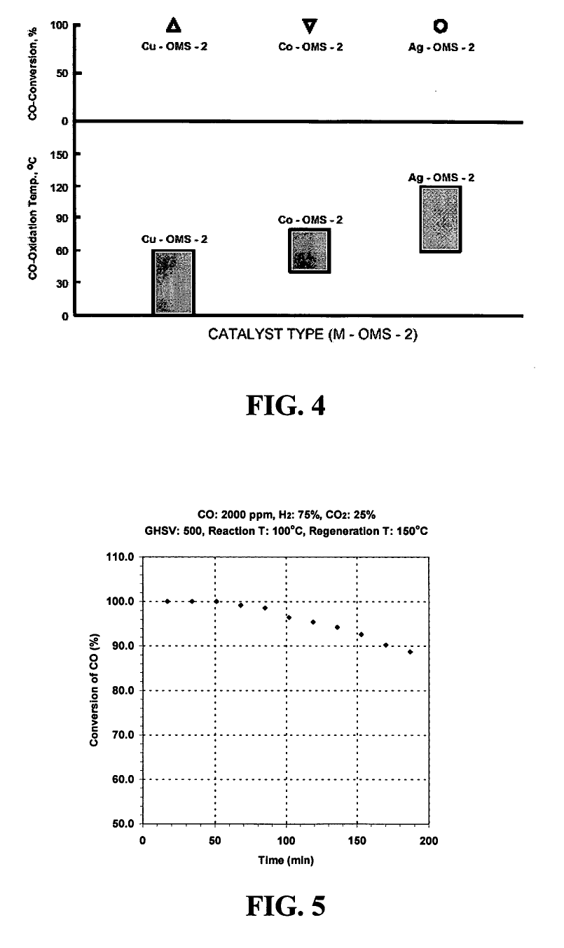

FIG. 4 shows a graph of performance data for Cu-OMS-2, Co-OMS-2 and Ag-OMS-2 catalysts, including the optimum operating temperatures for maximum carbon monoxide conversion by each of the catalysts. As can be seen in FIG. 4, the Cu-OMS-2 catalyst has the highest carbon monoxide conversion rates in a temperature zone between 0 and 60° Celsius, while the Co-OMS-2 catalyst performs best at temperatures between 40 and 90° Celsius. As also shown, the Ag-OMS-2 catalyst has the highest carbon monoxide conversion rate in the temperature zone between 80 and 120° Celsius.

As can be appreciated, in order to thermally efficiently integrate the carbon monoxide oxidizer 6 in the system 1 with the PEM fuel cell 2, it is preferable that the operating temperatures of the oxidizer 6 and the PEM fuel cell 2 be approximately the same. Since the operating range of the PEM fuel cell 2 is 80-120° Celsius, it is apparent that the operating range of the Ag-OMS-2 catalyst most closely matches this range and, therefore, an discussed above, is the preferable catalyst as among the three M-OMS-2 catalyst depicted.

The effectiveness of the Ag-OMS-2 catalyst in reducing carbon monoxide concentration in the PEM fuel cell feed or reformate gas was also tested over a period of time under the same conditions as described above. FIG. 5 shows a graph of performance data of the Ag-OMS-2 catalyst over a period of 200 minutes. As can be appreciated, OMS-2 materials include some free oxygen in their tunnels which is available for oxidation of carbon monoxide. As can be seen in FIG. 5, the Ag-OMS-2 catalyst converted 100% carbon monoxide to carbon dioxide for approximately 45 minutes, after which the amount of carbon monoxide converted began to decline. While not shown, after 1400 minutes of operation, the carbon monoxide conversion rate decreased to about 45%.

As can also be appreciated, the addition of oxygen to the PEM fuel cell feed or reformate gas and/or directly to the OMS-2 catalyst increases the amount of oxygen available for oxidation of carbon monoxide and therefore increases the length of time during which the 100% carbon monoxide conversion rate can be sustained. Accordingly, in accord with invention and as shown in FIG. 1, a controllable oxidant supply assembly 7 is provided in the system 1 to supply oxidant, e.g. air and/or oxygen, to the fuel feed and/or the oxidizer 6 in order to enhance the carbon monoxide oxidation.

Ag-OMS-2 catalyst samples made with the method of the invention were also tested using a simulated PEM fuel cell feed or reformate gas with added oxygen. The simulated reformate gas during these tests comprised 2000 ppm carbon monoxide, 2000 ppm oxygen, 24,000 ppm water, 75% hydrogen and 25% carbon dioxide.

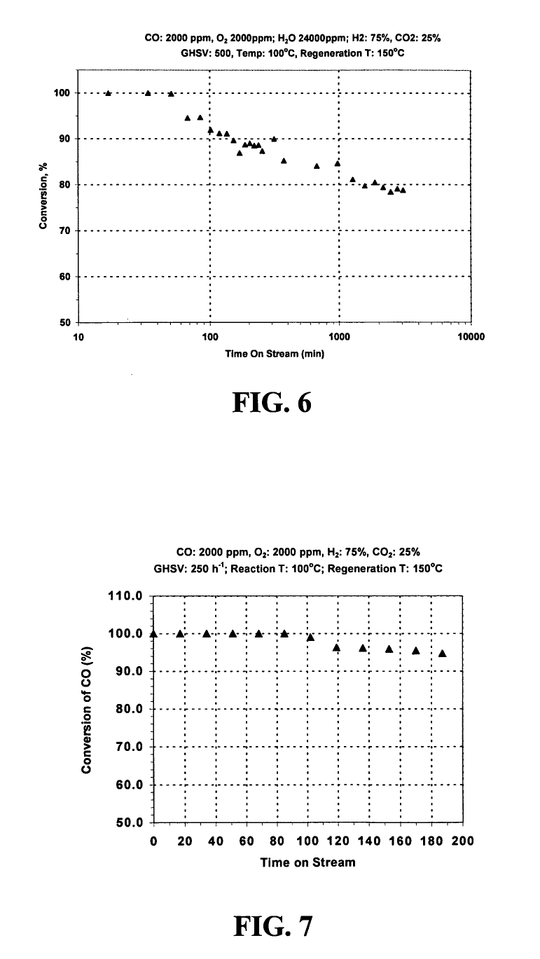

FIG. 6 shows a graph of performance data of the Ag-OMS-2 catalyst over a period of 10,000 minutes using the simulated reformate gas with added oxygen. This test was performed at a reaction temperature of 100° Celsius and 500 h⁻¹ space velocity. As shown, the Ag-OMS-2 catalyst converted 100% of carbon monoxide to carbon dioxide for approximately 60 minutes, and after 3000 minutes of operation, carbon monoxide conversion rate stabilized at approximately 80%.

In further accord with the invention, it has been recognized that the breakthrough time, which is a period of time during which 100% of carbon monoxide is converted by the OMS-2 catalyst, can be further increased by varying the space velocity of the PEM fuel cell feed or reformate gas passing through the catalyst. In particular, by decreasing the space velocity of the PEM feed, the residence time of the feed in the oxidizer, and, therefore, the catalyst, is increased, thereby increasing the breakthrough time. Accordingly, the system of FIG. 1 is provided with flow control assembly 8 permitting adjustment of the space velocity of the PEM fuel cell feed, to thereby achieve optimum carbon monoxide conversion.

The effect of controlling the space velocity to realize a longer breakthrough time is demonstrated in FIG. 7, which shows a graph of performance data for the Ag-OMS-2 catalyst using a simulated PEM fuel cell feed or reformate gas with added oxygen and with a space velocity of 250 h⁻¹. As shown in FIG. 7, the decrease in the space velocity from 500 h⁻¹ to 250 h⁻¹ further increased the breakthrough time to more than 90 minutes.

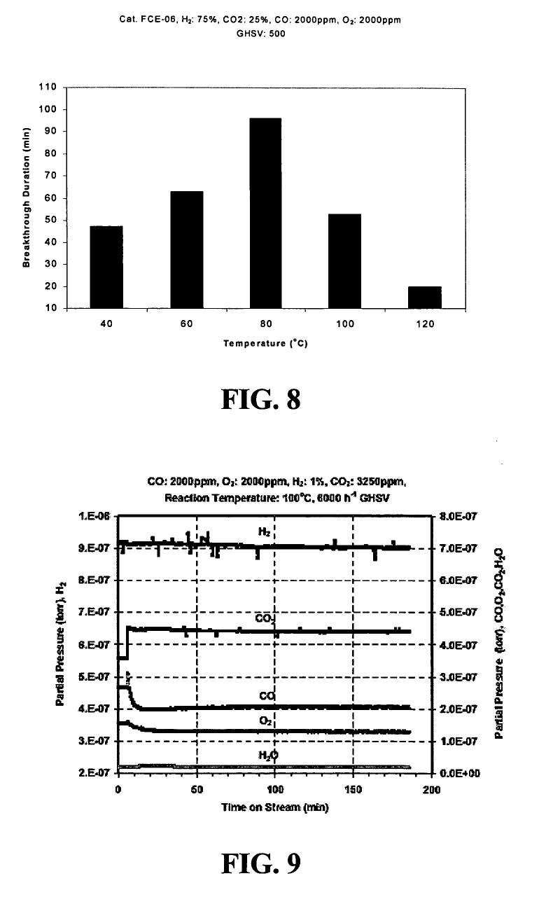

Also, in further accord with the invention, it has been found that increased breakthrough times could be realized by further controlling the operating temperature of the oxidizer via the temperature control assembly 9 shown in the system of FIG. 1. FIG. 8 shows a graph of breakthrough times using the Ag-OMS-2 catalyst at different temperatures between 40 and 100° Celsius. These tests were performed using a simulated reformate gas comprising 2000 ppm carbon monoxide, 2000 ppm oxygen, 75% hydrogen and 25% carbon monoxide. As can be seen in FIG. 7, the operating temperature of approximately 80° Celsius is the preferred temperature for the Ag-OMS-2 catalyst since the breakthrough duration at this temperature is the highest, thus providing a maximum capacity for carbon monoxide oxidation. Particularly, the breakthrough duration at 80° Celsius was over 95 minutes while the breakthrough times at lower or higher temperatures in the 40 to 120° Celsius temperature rage were lower.

In addition to the effective removal of carbon monoxide, carbon monoxide oxidation in the presence of the Ag-OMS-2 catalyst also exhibited no parasitic consumption of hydrogen. Tests on a simulated reformate gas were performed to evaluate hydrogen consumption during carbon monoxide oxidation reaction in the presence of the Ag-OMS-2 catalyst. The simulated reformate gas used during these tests comprised 2000 ppm carbon monoxide, 2000 ppm oxygen, 1% hydrogen and 3250 ppm of carbon dioxide. During these tests, the concentrations of hydrogen, carbon monoxide, carbon dioxide and oxygen concentrations during oxidation were analyzed using the GC-MS system and oxygen balance calculations. These tests were performed at a temperature of 100° Celsius and a gas space velocity of 6000 h⁻¹.

FIG. 9 shows a graph of partial pressures of the reformate gas components (i.e. of hydrogen, carbon dioxide, carbon monoxide, oxygen and water) over a period of 200 minutes. As can be seen, during the testing period, the concentrations of hydrogen and water in the reformate gas remained constant, showing no consumption of hydrogen during carbon monoxide oxidation over the Ag-OMS-2 catalyst. As also shown, after approximately 10 minutes of operation, the concentration of carbon monoxide rapidly declined until leveling out at about 2.0E-7 torr, while the concentration of carbon dioxide quickly increased over the same period of time and leveled out at approximately 4.4E-07 torr. Moreover, the concentration of oxygen in the reformate gas decreased over the same period of time (i.e. between 10 and 15 minutes of operation), indicating that oxygen was being consumed during conversion of carbon monoxide to carbon dioxide.

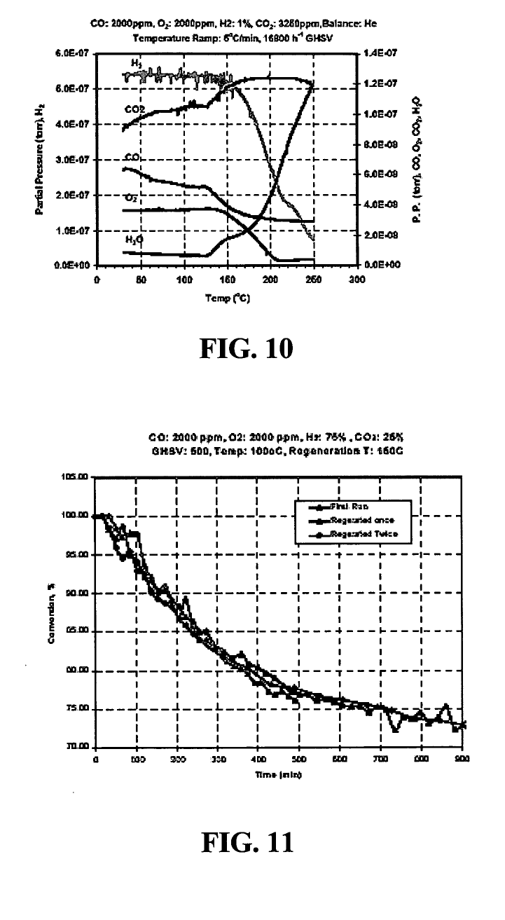

Temperature program reduction (“TPR”) tests using the simulated reformate gas with a space velocity of 16,800 h⁻¹ at various temperatures were also performed to confirm that no hydrogen was consumed during carbon monoxide oxidation over the Ag-OMS-2 catalyst. FIG. 10 shows a graph of partial pressures of the reformate gas components at different temperatures. As can be seen, the partial pressures of hydrogen and water in the reformate gas did not change during tests performed at temperatures below 120° Celsius.

According to the above tests it can be seen that carbon monoxide oxidation using the Ag-OMS-2 catalyst did not result in parasitic consumption of hydrogen when operated in the temperature range corresponding to the operating temperature of the PEM fuel cell.

As discussed above, the M-OMS-2 catalyst of the oxidizer can be regenerated by the application of an oxidant to the oxidizer 6. The system 1 is thus also provided with a regeneration control assembly which 11 which allows for this regeneration.

More particularly, regeneration was carried out in the system 1 with an Ag-OMS-2 catalyst for the oxidizer 6 and with oxygen/air as the regenerating medium. Regeneration temperatures were in the range of 150 and 200° Celsius for a period of 15 to 30 minutes. At the end of each regeneration cycle, the Ag-OMS-2 catalyst was used for carbon monoxide oxidation for 900 minutes.

FIG. 11 shows the results of the regeneration cycling for three cycles. As can bee seen, the catalyst regained its ability to provide 100% conversion of carbon monoxide after each of the regeneration cycles. This demonstrated that that complete regeneration of the Ag-OMS-2 catalyst could be realized with the application of oxygen or air for a period of 30 minutes at 150° Celsius.

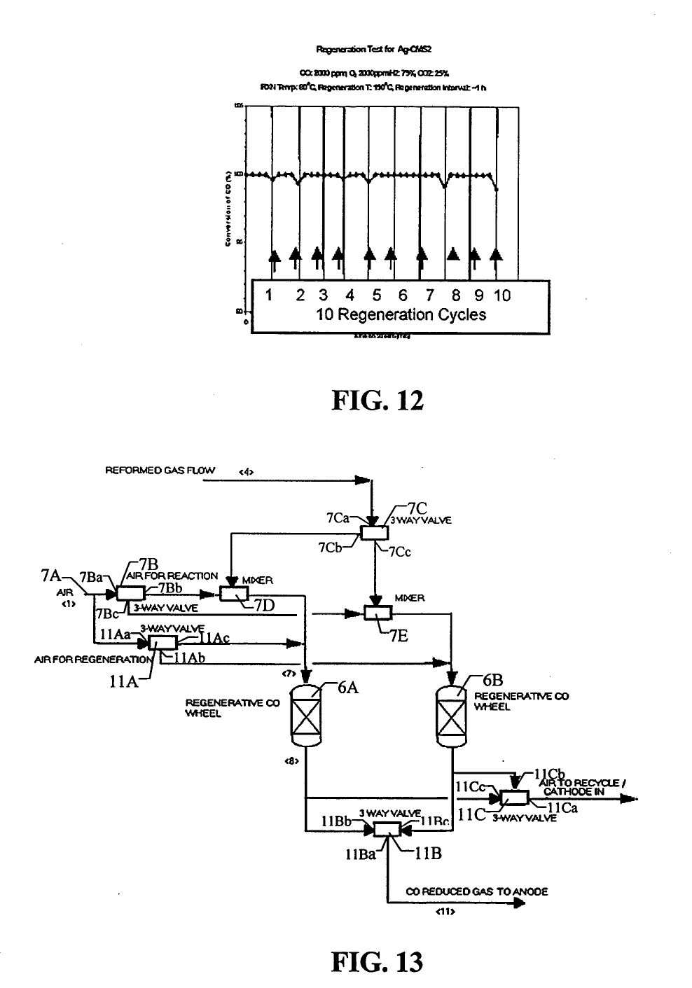

The regeneration of the Ag-OMS-2 catalyst was further tested by regenerating the catalyst at the end of breakthrough time for 100% carbon monoxide conversion. Each cycle contained 60 minutes of carbon monoxide conversion and 30 minutes of regeneration. Ten regeneration cycles were performed and the results, as shown in FIG. 12, indicate that 100% of carbon dioxide oxidation was restored after reach regeneration.

FIG. 13 shows a system configuration for realizing the oxidizer 6, the regeneration control assembly 11 and the controllable oxidant supply 7 shown in the system of FIG. 1. The oxidizer 6 comprises parallel packed bed reactors 6A and 6B having M-OMS-2 catalysts and the system is operated so that one reactor is performing carbon monoxide oxidation of the PEM fuel cell feed gas, while the other reactor is having its M-OMS-2 catalyst being regenerated. The controllable oxidant supply assembly 7 and the regeneration control assembly 11 are provided by the air supply 7A, the three way valve assemblies 7B, 7C, 11A, 11B, 11C and the mixers 7D and 7E. Each three way valve assembly 7B, 7C, 11A includes an inlet portion 7Ba, 7Ca, 11Aa, and two outlet portions 7Bb, 7Bc, 7Cb, 7Cc, 11Ab, 11Ac, while each three way valve assembly 11B, 11C includes two inlet portions 11Bb, 11Bc, 11Cb, 11Cc and one outlet portion 11Ba, 11Ca. The opening and closing of the outlet portions of the three way valve assemblies 7B, 7C, 11A, 11B, 11C is controlled by the flow control assembly 8 shown in FIG. 1.

The system of FIG. 13 operates as follows. If the bed reactor 6A is performing carbon monoxide oxidation of the PEM fuel cell feed gas and the bed reactor 6B is having its M-OMS-2 catalyst regenerated, the flow control assembly 8 controls the outlet portions 7Bb, 7Cb, 11Ab and the inlet portions 11Bb, 11Cb of the three way valve assemblies 7B, 7C, 11A, 11B, 11C to open, and the outlet portions 7Bc, 7Cc, 11Ac and the inlet portions 11Bc, 11Cc to close. During this operation, a portion of the air from the air supply 7A is carried through the three way valve assembly 7B to the mixer 7D where the air is mixed with the feed gas carried from the three way valve assembly 7C. The mixture of feed gas and air is carried to the bed reactor 6A where carbon monoxide in the feed gas is oxidized in the presence of the M-OMS-2 catalyst. Oxidized feed gas passes through the three way valve assembly 11B and is carried to the anode portion 2a of the PEM fuel cell.

Also during this operation, the remaining portion of the air from the air supply 7A is carried to the bed reactor 6B through the three way valve assembly 11A. The air regenerates the M-OMS-2 catalyst in the bed reactor 6B by replenishing the oxygen available in the catalyst for carbon monoxide oxidation. Air leaving the bed reactor 6B passes through the three-way valve assembly 11C and can then be used as oxidant gas in the cathode portion 2b of the PEM fuel cell.

If the bed reactor 6B is performing carbon monoxide oxidation of the PEM fuel cell feed gas and the bed reactor 6A is having its M-OMS-2 catalyst regenerated, the flow control assembly 8 controls the outlet portions 7Bc, 7Cc, 11Ac and the inlet portions 11Bc, 11Cc of the three way valve assemblies 7B, 7C, 11A, 11B, 11C to open, and the outlet portions 7Bb, 7Cb, 11Ab and the inlet portions 11Bb, 11Cb to close. In this case, a portion of the air from the air supply 7A is carried through the three way valve assembly 7B to the mixer 7E, where it is mixed with the fuel cell feed gas carried to the mixer 7E through the valve assembly 7C. The resulting mixture of feed gas and air is then supplied to the bed reactor 6B which oxidizes carbon monoxide in the feed gas as described above. Oxidized feed gas leaving the bed reactor 6B is carried through the valve assembly 11B and is then supplied to the anode portion 2a of the PEM fuel cell.

Concurrently, the remaining portion of the air from the air supply 7A is carried through the three way valve 11A to the bed reactor 6A to regenerate the M-OMS-2 catalyst in the bed reactor 6A. Spent air leaving the reactor 6A is carried through the valve 11C out of the system and can be used as oxidant gas in the cathode portion 2b of the PEM fuel cell.

In all cases it is understood that the above-described arrangements are merely illustrative of the many possible specific embodiments which represent applications of the present invention. Numerous and varied other arrangements can be readily devised in accordance with the principles of the present invention without departing from the spirit and scope of the invention.

What is claimed is:

1. A PEM fuel cell system in which a fuel feed having a carbon monoxide content is provided comprising:
an oxidizer adapted to receive said fuel feed and oxidize at least a portion of said carbon monoxide content, said oxidizer having an OMS-2 catalyst; and
a PEM fuel cell having a cathode compartment and anode compartment, said anode compartment receiving said fuel feed after passage through said oxidizer.

2. A PEM fuel cell system in accordance with claim 1, wherein:
said OMS-2 catalyst is an M-OMS-2 catalyst.

3. A PEM fuel cell system in accordance with claim 2, wherein:
said M-OMS-2 catalyst is one of Ag-OMS-2, Cu-OMS-2 and Co-OMS-2.

4. A PEM fuel cell system in accordance with claim 3, further comprising one or more of:
an assembly adapted to controllably supply oxidant to one or more of said fuel feed and said oxidizer;
an assembly adapted to control the space velocity of said fuel feed;
an assembly adapted to control said system so as to control the operating temperature of said oxidizer; and
an assembly adapted to regenerate said M-OMS-2 catalyst by supplying oxidant to said M-OMS-2 catalyst during inhibiting of said fuel feed to said M-OMS-2 catalyst.

5. A PEM fuel cell system in accordance with claim 2, further comprising one or more of:
a first assembly adapted to controllably supply oxidant to one or more of said fuel feed and said oxidizer;
a second assembly adapted to control the space velocity of said fuel feed;
a third assembly adapted to control said system so as to control the operating temperature of said oxidizer; and
a fourth assembly adapted to regenerate said M-OMS-2 catalyst by supplying oxidant to said M-OMS-2 catalyst during inhibiting of said fuel feed to said M-OMS-2 catalyst.

6. A PEM fuel cell system in accordance with claim 2, wherein:
said M-OMS-2 catalyst is Ag-OMS-2;
and said system includes an assembly adapted to control said system so that the operating temperature of said oxidizer is in the range of 50 to 1200 Celsius.

7. A PEM fuel cell system in accordance with claim 6, wherein:
said assembly is adapted to control said system so that the operating temperature of said oxidizer is in the range of 80 to 120° Celsius.

8. A PEM fuel cell system in accordance with claim 7, wherein:
said assembly is adapted to control said system so that the operating temperature of said oxidizer is about 80° Celsius.

9. A PEM fuel cell system in accordance with claim 2, wherein:
said M-OMS-2 catalyst is Cu-OMS-2;
and said system includes an assembly adapted to control said system so that the operating temperature of said oxidizer is in the range of 0 to 60° Celsius.

10. A PEM fuel cell system in accordance with claim 2, wherein:
said M-OMS-2 catalyst is Co-OMS-2;
and said system includes an assembly adapted to control said system so that the operating temperature of said oxidizer is in the range of 40 to 800 Celsius.

11. A PEM fuel cell system in accordance with claim 1, further comprising one or more of:
an assembly adapted to controllably supply oxidant to one or more of said hydrocarbon fuel feed and said oxidizer;
an assembly adapted to control the space velocity of said fuel feed;
an assembly adapted to control said system so as to control the operating temperature of said oxidizer; and
an assembly adapted to regenerate said OMS-2 catalyst by supplying oxidant to said OMS-2 catalyst during inhibiting of said fuel cell feed to said OMS-2 catalyst.

12. A PEM fuel cell system in accordance with claim 1, wherein:
said oxidizer comprises: first and second reactors each containing said OMS-2 catalyst; and
and said assembly is adapted regenerate said OMS-2 catalyst in said first reactor by supplying oxidant to said first reactor during inhibiting of said fuel feed to said first reactor and to regenerate said OMS-2 catalyst in said second reactor during inhibiting of said fuel feed to said second reactor.

13. A PEM fuel cell system in accordance with claim 12, wherein:
said assembly includes: an oxidant supply; and a valve assembly adapted to be responsive to said oxidant supply and to said fuel feed to control the flow of the oxidant and said fuel feed to said first and second reactors.

14. A PEM fuel cell system in accordance with claim 1, further comprising:
a hydrocarbon fuel supply;
a reformer adapted to reform the hydrocarbon fuel from said hydrocarbon fuel supply to said fuel feed containing carbon monoxide content.

15. A PEM fuel cell system in accordance with claim 14, further comprising:
a low temperature shift reactor adapted to receive the fuel feed from said reformer and reducing the carbon dioxide content of said fuel feed;
and said oxidizer receiving said fuel feed after passage through said low temperature shift reactor.

16. A PEM fuel cell fuel feed oxidizer adapted to oxidize at least a portion of the carbon monoxide in the fuel feed to a PEM fuel cell, said PEM fuel cell fuel feed oxidizer having an OMS-2 catalyst.

17. A PEM fuel cell fuel feed oxidizer in accordance with claim 16, wherein:
said OMS-2 catalyst is an M-OMS-2 catalyst.

18. A PEM fuel cell fuel feed oxidizer in accordance with claim 17, wherein:
said M-OMS-2 catalyst is one of Ag-OMS-2, Cu-OMS-2 and Co-OMS-2.

19. A PEM fuel cell fuel feed oxidizer in accordance with claim 18, wherein:
said M-OMS-2 catalyst is Ag-OMS-2.

20. A PEM fuel cell fuel feed oxidizer in accordance with claim 19, wherein:
said oxidizer is adapted to operate in the temperature range of 80 to 120° Celsius.

21. A PEM fuel cell fuel feed oxidizer in accordance with claim 18, wherein:
said M-OMS-2 catalyst is Cu-OMS-2; and
said oxidizer is adapted to operate in the temperature range of 0 to 60° Celsius.

22. A PEM fuel cell fuel feed oxidizer in accordance with claim 18, wherein:
said M-OMS-2 catalyst is Co-OMS-2; and
said oxidizer is adapted to operate in the temperature range of 40 to 80° Celsius.

23. A carbon monoxide oxidizing catalyst comprising Ag-OMS-2.

24. A carbon monoxide oxidizer comprising an Ag-OMS-2 catalyst.

25. A method of oxidizing a least a portion of the carbon monoxide content in the fuel feed to a PEM fuel cell comprising:
providing said fuel feed; and
passing said fuel feed through a OMS-2 catalyst.

26. A method in accordance with claim 25, wherein:
said OMS-2 catalyst is a M-OMS-2 catalyst.

27. A method in accordance with claim 26, wherein:
said M-OMS-2 catalyst is one of Ag-OMS-2, Cu-OMS-2 and Co-OMS-2.

28. A method in accordance with claim 27, further comprising one or more of:
adding oxidant to one or more of said fuel feed and said catalyst;
controlling the space velocity of said fuel feed;
controlling the temperature; and
regenerating said M-OMS-2 catalyst by supplying oxidant to said catalyst during inhibiting of fuel feed to said catalyst.

29. A method in accordance with claim 26, further comprising one or more of:
adding oxidant to one or more of said fuel feed and said catalyst;
controlling the space velocity of said fuel feed;
controlling the temperature; and
regenerating said M-OMS-2 catalyst by supplying oxidant to said catalyst during inhibiting of fuel feed to said catalyst.

30. A method in accordance with claim 25, further comprising one or more of:
adding oxidant to one or more of said fuel feed and said catalyst;
controlling the space velocity of said fuel feed;
controlling the temperature; and
regenerating said OMS-2 catalyst by supplying oxidant to said catalyst during inhibiting of fuel feed-to said catalyst.

31. A method of oxidizing a least a portion of the carbon monoxide content in a feed comprising:
providing said feed; and
passing said feed through an Ag-OMS-2 catalyst.

32. A method of making an M-OMS-2 catalyst comprising the steps of:
preparing a precipitate using as precursors a metal salt and a manganese salt, wherein a concentration of metal is between 0.0001M and 0.05M and wherein an average oxidation state of manganese is between 2.8 and 4.0;
drying said precipitate; and
calcinating said precipitate after said drying.

33. A method of making an M-OMS-2 catalyst in accordance with claim 32, further comprising a step of refluxing and filtering said precipitate before said drying step.

34. A method of making an M-OMS-2 catalyst in accordance with claim 33, wherein said metal is one of copper, cobalt and silver.

35. A method of making an M-OMS-2 catalyst in accordance with claim 34, wherein said metal is silver.

36. A method of making an M-OMS-2 catalyst in accordance with claim 35, wherein said average oxidation state of manganese is between 3.7 and 4.0.

37. A method of making an M-OMS-2 catalyst in accordance with claim 36, wherein said precipitate has a pH of 1.

38. A method of making an M-OMS-2 catalyst in accordance with claim 37, wherein said refluxing step is carried out for 24 hours.

39. A method of making an M-OMS-2 catalyst in accordance with claim 38, wherein said drying step is carried out at 100 to 150° Celsius.

40. A method of making an M-OMS-2 catalyst in accordance with claim 39, wherein said calcinating step is carried out at 350° Celsius for two hours.

41. A method of making an M-OMS-2 catalyst in accordance with claim 34, further comprising a step of pelletizing and sieving said precipitate after said calcinating step.

42. A method of making an M-OMS-2 catalyst in accordance with claim 41, wherein said precipitate is sieved to particles between 20 and 60 mesh.
